(19) United States
(12) Patent Application Publication
(10) Pub. No.: US 2024/0239606 A1
(43) Pub. Date: Jul. 18, 2024

(54) SYSTEM AND METHOD FOR REAL-TIME ORDER PROJECTION AND RELEASE

(71) Applicant: Dematic Corp., Grand Rapids, MI (US)

(72) Inventors: Matthew Haley, Raleigh, NC (US); Sunil Nakrani, Peachtree City, GA (US); Murat Cubuktepe, Austin, TX (US); Aleksandar Krnjaic, Lilyfield NSW (AU); Chaitanya Maniar, Marietta, GA (US); Brett D. Webster, Austin, TX (US)

(21) Appl. No.: 18/415,790

(22) Filed: Jan. 18, 2024

Related U.S. Application Data
(60) Provisional application No. 63/480,346, filed on Jan. 18, 2023.

(51) Int. Cl. B65G 1/137

(52) U.S. Cl. CPC B65G 1/1375

(57) ABSTRACT

An order fulfillment control for a warehouse includes a controller, a memory, a current state storage, and a training module. The controller controls fulfillment activities and issues orders to pickers. The controller controls the issuance of the orders and records operational data corresponding to the fulfillment activities in the warehouse. The memory holds operational data. The current state storage holds live data corresponding to the current state of the warehouse defined by selected portions of the operational data. The inference module includes an order release control to issue an order release recommendation to the controller when a set of live data is received from the current state storage. The training module retrains the order release controls. The training module performs reinforcement learning on the operational data to retrain and update the order release control. The order release control is retrained based upon priorities for optimal operation of the warehouse.

### CROSS REFERENCE TO RELATED APPLICATION

The present application claims the priority benefits of U.S. provisional application, Ser. No. 63/480,346 filed Jan. 18, 2023, which is hereby incorporated herein by reference in its entirety.

### FIELD OF THE INVENTION

The present invention is directed to the control of order picking systems in a warehouse environment for order fulfilment, and in particular to controls used to aid in managing the release of orders in order picking systems.

### BACKGROUND OF THE INVENTION

The control of an order picking system with a variety of workers or agents (e.g., human pickers, robotic pickers, item carrying vehicles, conveyors, and other components of the order picking system) in a warehouse is a complex task. Conventional algorithms are used to seek various objectives in an ever-increasing order fulfillment complexity characterized by scale of SKU variety, order composition ranging from single SKU to multiple SKUs, widely varying order demand in magnitude and time scales coupled with the very demanding constriction of delivery deadline. In recent times, this complexity is further compounded by recent labor shortages on one hand and the unforeseen dependence on e-commerce to support day-to-day activities.

### SUMMARY OF THE INVENTION

Embodiments of the present invention provide methods and a system for a highly flexible solution for dynamically responding to changing warehouse operations and order conditions for both individual agents or workers and for changing facility objectives. Such responses include real-time order projection and efficient order release to maintain optimal facility efficiency.

An order fulfillment control system for a warehouse in accordance with the present invention includes a controller or computer control system with operational software including a memory module, a current state data storage, and a training module. The controller controls fulfillment activities of the warehouse and issues orders to pickers. The controller adaptively controls the issuance of the orders and records operational data corresponding to the fulfillment activities in the warehouse. The memory module holds operational data. The current state data storage holds live data corresponding to a current state of the warehouse defined by selected portions of the operational data. The inference module includes an order release control, e.g., a computer control system operating an algorithm or other control process. The inference module issues an order release recommendation to the controller when a set of live data is received from the current state data storage. The order release recommendation is defined by the order release control with respect to the set of live data. The training module retrains the order release control using reinforcement learning techniques. The training module performs the reinforcement learning using the operational data to retrain and update the order release control. The training module retrains the order release control based upon a plurality of priorities for optimal operation of the warehouse.

A method for controlling order fulfillment in a warehouse in accordance with an embodiment of the present invention includes controlling fulfillment activities in the warehouse and issuing picking orders to pickers. The issuance of orders to pickers is adaptively controlled. The method includes recording operational data corresponding to the fulfillment activities in the warehouse. The operational data is held in a memory module. The method includes holding live data in a current state data storage. The live data corresponds to the current state of the warehouse defined by selected portions of the operational data. The method also includes issuing an order release recommendation when a set of live data is received from the current state data storage. The order release recommendation is defined by an order release control with respect to the set of live data. The order release control is retrained using reinforcement learning techniques. The reinforcement learning is performed with the operational data to retrain and update the order release control. The order release control is retrained based upon a plurality of priorities for optimal operation of the warehouse.

A non-transitory computer-readable medium with instructions stored thereon, that when executed on a processor, performs the following steps: controlling fulfillment activities in a warehouse; issuing orders to pickers, wherein the issuance of orders is adaptively controlled; and recording operational data corresponding to the fulfillment activities in the warehouse. The operational data is held in a memory module. Live data is held in a current state data storage. The live data corresponds to a current state of the warehouse defined by selected portions of the operational data. An order release recommendation is issued when a set of live data is received from the current state data storage. The order release recommendation is defined by an order release control with respect to the set of live data. The order release control is retrained using the operational data to retrain and update the order release control. The retraining is based upon a plurality of priorities for optimal operation of the warehouse.

In an aspect of the present invention, the training module is operable to retrain the order release control by providing the order release control with a plurality for picking orders for the order release control to coordinate and release for fulfillment in a simulation. The plurality of picking orders are based upon operational data stored in the memory module. The training module awards numerical penalties and positive rewards based upon evaluated results of the completion of orders as they are released by the order release control.

In another aspect of the present invention, operational data is at least one of: operational data recorded during performance of operational tasks within the warehouse; simulation data configured to simulate warehouse operations; and synthetic data configured to mimic the operational data.

In a further aspect of the present invention, the plurality of picking orders corresponds to an historical day's quantity of picking orders completed on that day. Alternatively, the plurality of picking orders corresponds to a hypothetical day's quantity of picking orders to be completed that day.

In another aspect of the present invention, the warehouse comprises at least one order channel. Each of the at least one order channel comprises a corresponding set of resources that are used to complete an order assigned to that order channel.

In a further aspect of the present invention, the plurality of priorities for optimal operation of the warehouse comprise at least one of: balancing orders between order channels of the at least one order channel, proportionality of the orders released as compared to the orders still awaiting release, issuing order releases such that order channels of the at least one order channel are not starved nor congested.

In an aspect of the present invention, the controller is operable to direct the training module to retrain the order release control after a selected time interval or when a measured metric is determined to be outside of an operational window.

In another aspect of the present invention, the orders are picking orders and the pickers are human pickers and/or robotic pickers.

In a further aspect of the present invention, the order release control is retrained using a plurality of picking orders for the order release control to coordinate and release for fulfillment in a simulation. An environment for order fulfillment and the plurality of picking orders are based upon operation data stored in the memory module. The penalties and rewards are granted based upon evaluated results after the completion of orders as they are released by the order release control.

In yet another aspect of the present invention, the operational data includes at least one of: operational data recorded during performance of operational tasks within the warehouse; simulation data configured to simulate warehouse operations; and synthetic data configured to mimic the operational data.

In an aspect of the present invention, the plurality of picking orders comprises at least one of: one or more historical day's quantity of picking orders completed on respective days, and at least one hypothetical day's quantity of picking orders to be completed on a hypothetical day.

In another aspect of the present invention, the warehouse includes a plurality of order channels. Each of the order channels includes a corresponding set of downstream resources and associated requirements. The two or more order channels of the plurality of order channels share upstream resources.

In a further aspect of the present invention, the priorities for optimal operation of the warehouse includes balancing orders between order channels, a proportionality of the orders released as compared to orders still awaiting release, and issuing order releases such that order channels are not starved nor congested.

In an aspect of the present invention, the order release control is retrained after a selected time interval or when a measured metric is determined to be outside of an operational window. The measured metric is one or more of: production metrics and performance metrics.

The present invention thus provides an adaptable system and method for fulfilling orders that is operable to learn based on warehouse conditions to optimize performance under varying circumstances and conditions. The system and method of the present invention thus avoids and overcomes difficulties with conventional order fulfilment systems and controls utilizing fixed algorithms that require significant effort to design, test, optimize, program, and implement, and are usually very specific to customer requirements. Such conventional systems do not adjust well to changing warehouse/order fulfillment operations or conditions. Furthermore, the optimality of the algorithms for various agents can vary (e.g., the operational strategies for individual agents or workers may be different than the operational strategies for a facility as a whole).These and other objects, advantages, purposes and features of the present invention will become apparent upon review of the following specification in conjunction with the drawings.

### BRIEF DESCRIPTION OF THE DRAWINGS

FIG. 1A is a schematic overhead plan view of an exemplary order fulfilment facility in which a control system in accordance with the present invention is employed;

FIG. 1B is a block diagram of an exemplary aspect of a fulfillment facility employing the control system in accordance with the present invention;

FIG. 2 is a block diagram of an exemplary order fulfillment and control system in accordance with the present invention;

FIG. 3 is another block diagram of the order fulfillment and control system of FIG. 2 illustrating a process for real-time order projection and order release in accordance with the present invention; and

FIG. 4 is an enlarged partial view taken at section II of the order fulfillment system of FIG. 3 and illustrating an exemplary RL agent training system in accordance with the present invention.

### DESCRIPTION OF THE PREFERRED EMBODIMENTS

The present invention will now be described with reference to the accompanying figures, wherein numbered elements in the following written description correspond to like-numbered elements in the figures. With the industry evolving towards software intensive and intelligent autonomous solutions in order fulfillment strategies, exemplary strategies and solutions must blend fixed and mobile automation (hardware) with flexible workflows (software) and real-time end-to-end visibility with artificial intelligence (AI) enabled decision support capabilities (for the order fulfillment process within a given location). Exemplary methods, non-transitory computer-readable media with instructions for performing process steps, and systems provide for highly flexible solutions for dynamically responding to changing warehouse operations and order conditions for anticipated orders and in-progress orders, and for changing facility objectives and conditions. A warehouse management system includes an exemplary control system providing real-time order projection and flexible order release based upon the current state of the fulfillment system. The control system includes a reinforcement learning-trained order release control/agent model (also referred to as an agent model) for optimizing order release strategies. As described herein, the agent model is trained (and periodically retrained as necessary) to dynamically adjust the work in progress (within the order channels of an order fulfillment facility) to find an optimal level for order release and thus maximize efficiency and stability.

An exemplary fulfillment facility or host facility's warehouse management system includes order information, which is provided to the control system. As described herein, the control system controls the aggregation and release of orders to the fulfillment facility. When an order is “released,” it becomes eligible for work to be performed within the fulfillment facility required to complete that order. That is, a picking system within the fulfillment facility can begin executing picks for this order. The picking system can utilize a variety of agents and means for completing the order. Based on an order's characteristics, it is released to an order channel within the fulfillment facility. An exemplary order fulfillment system 100 includes a plurality of order channels, with each order channel dedicated to a particular type of order fulfillment for a particular order (e.g., order fulfillment tasks for e-commerce, retail/store, and value added services (VAS)). Each order channel may be defined according to its particular downstream resources and/or requirements. Such resources can include, for example, picking resources (discrete or batch picking for orders) and equipment utilized in order consolidation. For example, picks for a released order may be directed to a “put wall” downstream, or to a grid for a larger store or retail establishment. Typical order channels include single-unit e-commerce, multi-unit e-commerce, retail/store, value added services (VAS), etc. Distinct order channels may share upstream picking resources but are completed at unique downstream stations. Single-unit (SU) e-commerce orders consist of a single quantity of a SKU and are usually processed at a dedicated “singles packout” station. Multi-unit (MU) orders consist of one or more quantity of multiple SKUs and are usually consolidated at a put-wall consolidation station before being packed at the put-wall or at a further downstream station. Larger retail/store orders consist of many SKUs and quantities and must be consolidated at special large capacity stations or directly to pallet on a put-to-store grid location. Value added services (VAS) orders can be single or multi-SKU, but are usually processed at a station that adds some form of customization to the order, such as, assembly, tagging, labeling, etc.

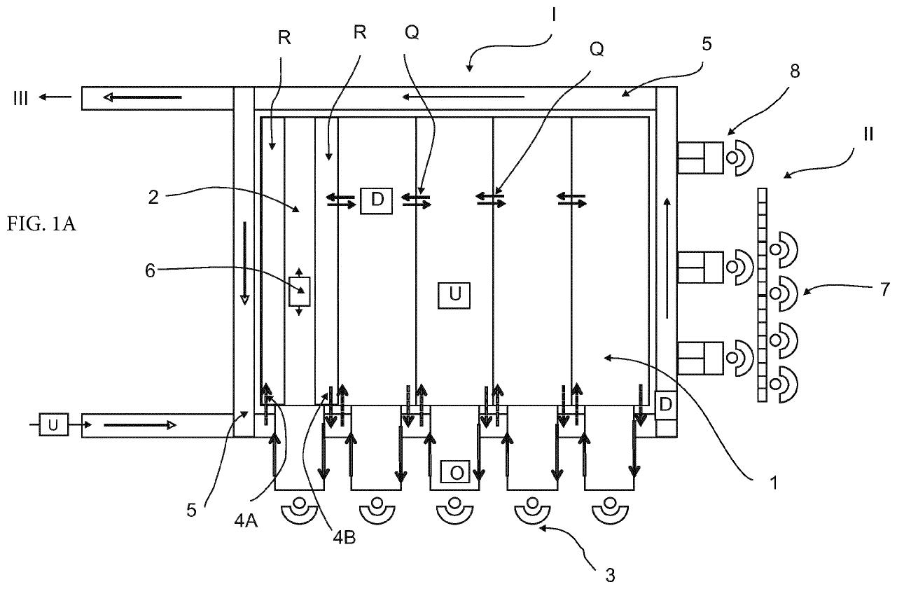

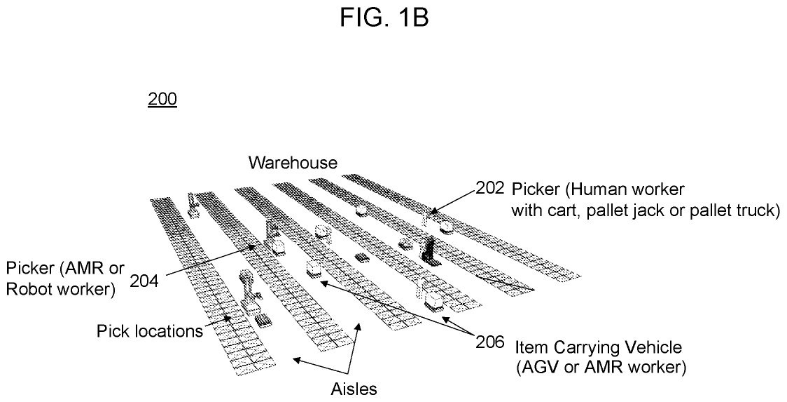

FIGS. 1A and 1B illustrate exemplary warehouse environments or aspects thereof in which order fulfillment activities are taking place. It should be appreciated that order fulfilment systems employing control systems in accordance with the present invention may be configured and employed in numerous ways and environments utilizing variously configured and differing material storage and handling systems. Accordingly, the below discussion of the systems of FIGS. 1A and 1B should be understood as non-limiting and provided for explanatory purposes.

With reference to FIG. 1A, an exemplary warehouse or storage facility for order fulfilment is disclosed for use with control systems in accordance with aspects of the present invention. As illustrated, the order fulfilment facility includes an automated storage and retrieval racking area I and a routed products order picking area II. The automated storage and retrieval racking area I is arranged upstream from the routed products order picking area II and is connected to the routed products order picking area II by a routing conveyor 5, which eventually leads to a shipping area III, but may also loop back to the entry/exit of the automated storage and retrieval racking area I. The automated storage and retrieval racking area I comprises a storage racking 1 comprising a plurality of multilevel storage racks R in which units U are stored for fulfilling orders, where the storage racks R include aisles 2. The aisles 2 are connected to semi or full-automated picking stations 3 through conveyor installations 4, which include storage-entry conveyor 4A provided for feeding product units U into the storage racking 1, and storage-exit conveyors 4B provided for retrieval of product units U from the storage racking 1. The semi/fully automatic picking stations 3 are configured for picking from retrieved product units D into order units O for fulfilling orders, which are fed by the at least one storage-exit conveyor 4B to the picking stations 3. The routing conveyor 5 is also connected to the inbound storage-entry conveyor 4A and the storage-exit conveyor 4B. In this manner, the routing conveyor 5 forms a loop connecting the picking stations 3, inbound storage-entry conveyors 4A and storage-exit conveyors 4B, the routed products picking area II and the shipping area III. Each aisle 2 includes one or more automatic storage and retrieval shuttles 6 for storage and retrieval of product units into and from the storage racks R. Product units U may be exchanged directly between two adjoining storage racks R from a source storage rack to an adjacent destination storage rack via cross conveyance locations Q in the storage racks themselves. The shuttle 6 itself may displace the product units U in the cross-conveyance locations Q actively via integrated load handlers, which may be configured as telescopic arms on both sides of a loading platform that are equipped with unit handling levers. As described, the semi/fully automatic picking stations 3 are sourced by the automated storage 1 for picking from product units D into order units O for fulfilling orders. To do so the items needed to fulfil a certain order are transferred to the semi/fully automatic picking stations 3. As order levels rise, more picking stations 3 may be manned/used. Product units D may also be discharged from the automated storage and retrieval racking area I to the routed products picking area II, which picking stations may include manually operated put-walls 7 and pick/pack stations 8, where the looped routing conveyor 5 transports product units D to the manually operated put-walls 7 and pick/pack stations 8 according to order fulfilment requirements based upon warehouse management controls. At the put-wall 7 operators may use the put-wall cubby holes for buffering product units for later consolidation of units for orders. Put-walls 7 may additionally or alternatively be positioned at the picking stations 3. Still further, an automated put-wall may be employed. For example, the routed products order picking area II may include an automated put-wall that is integrated into the last aisle of the automated storage and retrieval racking area I and therefore forms an interface between both areas, where order units may be automatically buffered therein by a shuttle 6, robot or other automated conveyance device.

With reference to FIG. 1B, the warehouse environment 200 includes a variety of different agents 202, 204, 206. Each class of agents has distinct objectives and capabilities. The agents illustrated in FIG. 1B include human pickers 202, robotic pickers 204 (which usually come in the form of autonomous mobile robot (AMRs)), and item carrying vehicles 206 (in the form of automated guided vehicles (AGVs) or autonomous mobile robots (AMRs)), configured to carry items picked by the human pickers 202 and/or the robotic pickers 204. Alternatively, the AGVs may be substituted with AMRs configured for carrying the picked items. The overall logistics of the warehouse 200 would be distributed across the classes of agents 202, 204, 206. Additional agents would include fixed automation assets in the warehouse 200 as well as fulfillment management systems (e.g., WES, WCS, and WMS). The agents 202, 204, 206 are allocated and/or assigned to one or more order channels within the warehouse 200 (which are managed by the order fulfillment system 100 and the order management system 102).

When an order is released to a particular order channel, the channel's resources are used to complete the order. Such order channels can include order channels for put-wall cubbies (i.e., smaller customer orders for the smaller working space of the cubbies). Such order channels can include e-commerce multi-unit (MU) orders. Other order channels include orders for put-to-store grids where pallets of goods/items are built. Such orders would be larger store/retail orders. Within the order channels of the facility, there will be different parallel processes that share different resources of the facility. For example, manual picking (human) may fulfill multiple orders simultaneously, but these different orders would go to different downstream destinations, so they would be considered separate order channels. As described herein, a benefit of the exemplary embodiments is the balancing of orders across the order channels of the facility such that orders are released in a fashion that is proportional to the order channels, the orders in progress, and the pending orders still to be completed in the various order channels. Orders are released such that all the order channels are kept busy, and without starving an order channel of work while causing congestions and back-up in another order channel with too many orders being executed at the same time.

Controlling an order picking system (e.g., a person-to-good batch picking) and its order release process, is a complex assignment involving many different agents (e.g., human and robotic pickers, transportation means, and autonomous storage and retrieval systems) and tasks for them to perform. Conventionally, many of the controls or algorithms used in order fulfillment are hand-tuned to fit the facility in question, which can be suboptimal as the optimal strategy for order fulfillment activities can be dependent on the current state of the system. The hand-tuning also leads to increased workload as a lot of effort has to be put into designing, testing, optimizing, programming, and implementing the controls to fit specific customer requirements. To solve this, the embodiments described herein utilize an exemplary agent model to optimize a specific order fulfillment activity, namely order release actions, based on multiple data points in the order fulfillment system.

In exemplary order fulfillment picking activities, a high density of picking is desirable as it enables a higher throughput with the same amount of picking resources. When more orders are released to the order fulfillment facility, such order release should result in a higher “density” of picking. That is, pickers will have to walk or move a reduced distance between picks if there are more picks to perform. To that end, injecting more work into the system is beneficial, but only up until the point injecting more work orders causes overflow in downstream consolidation areas. For example, analogous to a control problem, letting orders be released to flow into the system is like opening a valve, whereas throttling order release into the system is like shutting that valve. If too many orders are released into execution simultaneously, it causes the system to “overhead,” overflowing, for example, put-wall cubbies with a finite quantity of cubbies, or similar order assembly solutions at downstream workstations will fill up and there will not be adequate space to deal with all the items that have been picked and are being delivered to the downstream workstations. Accordingly, the exemplary agent model is trained to treat the fulfillment facility as a control system where order release decisions are tuned to keep the system stable and maximally efficient (e.g., maximum number of orders released for execution as possible without undue congestion downstream and/or starvation of orders for the facility's order channels).

As discussed herein, rather than a solution for controlling order release in a continuous flow scenario which depends on static decision making by using a fixed order-release factor that multiplies the downstream resource count, yielding a fixed target work in process (WIP) that is maintained, an exemplary dynamic WIP level at any given time could depend on the current state of the order fulfillment system 100, such as how many orders are currently “in picking” or “in transit,” etc. An evolution or adjustment of the order fulfillment system 100 in response to agent decisions can be viewed as a Markov process, the dynamics of which could be implicitly encoded in policy and value networks of the reinforcement learning systems described herein. Another consideration of the exemplary order fulfillment system 100 during order release is when there are multiple order channels sharing some resource, such as the same pickers executing multi-unit and single-unit picking. If too many orders of a particular channel are released, it could adversely affect the other channel, causing delays or even work starvation at the neglected channel's downstream resources. Thus, the exemplary reinforcement learning agent could consider utilization and cycle time in its reward criteria during the training process described herein.

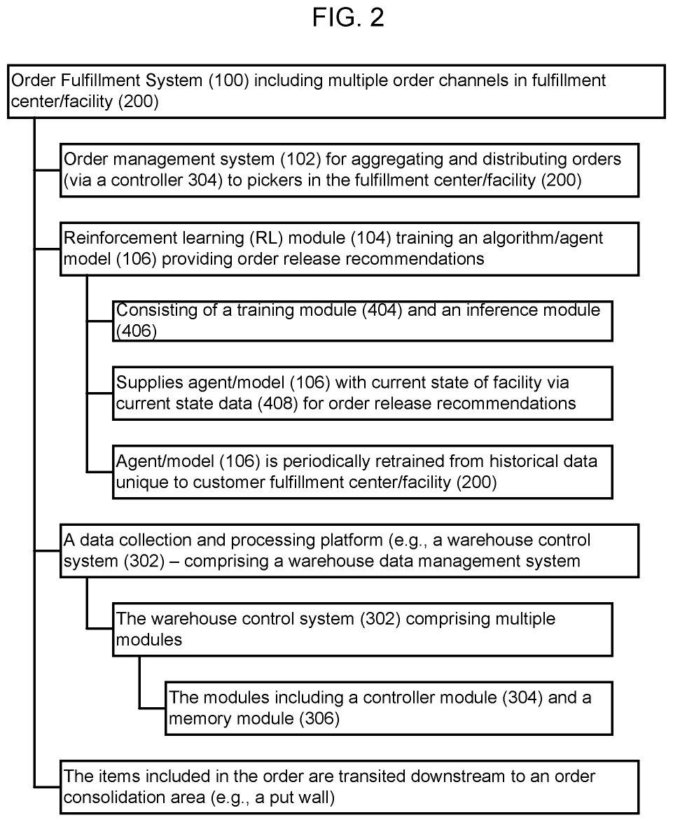

Referring to FIGS. 1 and 2, an exemplary order fulfillment system 100 for a fulfillment facility 200 includes a control system with a neural network for order release decision-making (an exemplary order release control/agent model or agent model) that is trained by reinforcement learning methodologies to consider the current state of the facility 200 and to determine an optimal quantity and selection of orders to release at a given moment. Thus, it could be considered a risk-management agent where orders are released in such a fashion that the orders are released in a proportional fashion with respect to the order channels, the quantity of orders in progress (within each order channel), the state of the in-work orders and their expected completion, and the quantity of future orders still to be completed (within each order channel). For example, if orders are to be released in a MU order channel and a SU order channel, based on the orders in progress (e.g., 300 MU orders and 100 SU orders, where 75% of the MU orders are close to completion, and 25% of the MU orders are in the middle of their work, while 50% of the SU orders are early in the start of completion). If, for example, future work includes 1000 MU orders and 100 SU orders, the agent model may recommend an order release solution where the remaining orders are balanced across the channels (especially if they share resources), such that more of the remaining MU orders are released at a time as compared to the quantity of SU orders to be released. Such risk assessment is possible through reinforcement learning where the order release agent/model is trained on historical production data from the facility 200.

Reinforcement learning is a type of artificial intelligence aiming at learning effective behavior in an interactive, sequential environment based on feedback and guided trial-and-error (such guided or intelligent trail-and-error is to be distinguished from mere blind or random trail- and-error). In contrast to other types of machine learning, RL usually has no access to any previously generated datasets and iteratively learns from collected experience in the environment (e.g., the collected historical operational data). While the reinforcement learning has been performed based upon recorded historical data based upon historical orders fulfilled in the facility, alternative training data could be used. For example, the training data could be simulated data configured to simulate facility operations (e.g., a fictional workday comprising a selected assortment of orders for fulfillment), and/or synthetic data configured to mimic the historical operational data. Reinforcement learning can include intelligent trial and error (e.g., simulating 1000's of days of facility operations. On some simulated days, the agent model might release too many orders (and receive a penalty or negative credit), while on other days the agent model might release too few orders (resulting in another penalty). By honing in on a “balance” between too many orders, or too few orders, the agent model determines how many (and which) orders should be released given the current state of the facility and the future orders to be released. In one embodiment, the agent in training can be retrained or updated and returned to training.

Referring to FIGS. 1, 3, and 4, the order fulfillment system 100 includes an order management system 102 responsible for aggregating and distributing orders to agents (human and robotic) in the order fulfillment system 100. The order fulfillment system 100 and/or order management system 102 receive and/or possess customer info related to the orders awaiting release for execution by the order fulfillment system 100. As discussed herein, the released orders can include orders for manual picking and/or automated picking via automated storage and retrieval systems (AS/RS). The order fulfillment system 100 also includes a data collection and processing platform (referred to herein as a warehouse control system or control system) 302, and a reinforcement learning agent 104 (comprising a training module 404 and an inference module 406) for determining an optimal rate of order release to one or more order channels based upon in-work orders projections and future order to be completed. An exemplary order fulfillment system 100 also includes an order picking system 310 for coordinating and aggregating the orders to be released to the human or robot agents (pickers/putters). From the order picking system 310, the picked orders are transferred via a transit 312 (e.g., a conveyor or other means of transportation) to a downstream consolidation zone consisting of, for example, put wall workstations 314 or other similar solutions where order components dwell until the full order has been assembled and released to an outboard department 316 for shipping and other processing needs.

It is understood that such controls, controllers, and modules of the exemplary embodiments can be implemented with a variety of hardware and software, including CPUs and/or GPUs, as well as AI accelerator hardware, including spiking neural networks, such as, neuromorphic computational systems or neuromorphic chips, field-programmable gate arrays (FPGAs), and purpose-built circuitry, that make up one or more computer systems or servers, such as operating in a network, comprising hardware and software, including one or more programs, such as cooperatively interoperating programs and/or computers. For example, an exemplary embodiment can include hardware, such as, one or more processors on one or more computers configured to read and execute software programs. Such programs (and any associated data) can be stored and/or retrieved from one or more storage devices. The hardware can also include power supplies, network devices, communications devices, and input/output devices, such devices for communicating with local and remote resources and/or other computer systems. Such embodiments can include one or more computer systems and are optionally communicatively coupled to one or more additional computer systems that are local or remotely accessed. The one or more controllers may include one or more processors, including one or more single-core and/or multi-core processors, such as configured to perform AI operation. Such microprocessors may be a digital signal processor (DSP), a general purpose core processor, a graphical processing unit (GPU), a computer processing unit (CPU), a microprocessor, an AI processing unit, an neural processing unit, a silicon-on-chip, a graphene-on-chip, a neural network-on-chip, a neuromorphic chip (NeuRRAM), a system on a chip (SoC), a system-in-package (SIP) configuration, or any suitable combination of components used for the operations as depicted and described herein. Certain computer components of the exemplary embodiments can be implemented with local resources and systems, remote or “cloud” based systems, or a combination of local and remote resources and systems. The software executed by the computer systems of the exemplary embodiments can include or access one or more algorithms for guiding or controlling the execution of computer implemented processes, e.g., within exemplary warehouse order fulfilment systems. As discussed herein, such algorithms define the order and coordination of process steps carried out by the exemplary embodiments. As also discussed herein, improvements and/or refinements to the algorithms will improve the operation of the process steps executed by the exemplary embodiments according to the updated algorithms. Such algorithm improvements may be extended to hardware using neuromorphic computer techniques such that one or more processors are reconfigurable (e.g., an AI processor) and thus enabling the development of multipurpose hardware and firmware.

As illustrated in FIGS. 1, 3, and 4, the warehouse control system 302 includes a controller module 304 and a memory module 306. The warehouse control system 302 is configured for data collection, data processing, and management of the facility 200. As discussed herein, the memory module 306 is configured for storing operational data, while the controller 304 is operable to control the activities of the fulfillment center and to record the operational data stored in the memory module 306. As discussed herein, the control system 302 is also configured to determine when the agent model 106 needs to be retrained. Alternatively, another system within the order fulfillment system 100 determines when the agent model 106 needs to be retrained.

The RL agent 104 receives data from the control system 302 and trains (via reinforcement learning) the agent model 106 for optimized order release recommendations. The trained agent model 106, at the inference module 406, is supplied with knowledge of the state of completion of current work in progress (WIP) via the current state data 408 which contains the current state of the facility 200 and its work in progress. Based upon the current state of the work underway in the facility 200 (and a consideration of the future work to be completed), the inference module 406 (via the agent model 106) provides a recommendation to the order management system 102 for order release to the order picking system 310. In one embodiment, the controller 304 is a part of a warehouse execution system (WES) responsible for order release. The controller 304 communicates with the inference module 406 for order release guidance. The controller 304 may be responsible for more details of the order release decision, such as, inventory allocation or sequence of order release, while the inference module 406 determines (and recommends) how many orders to release at any given time given the current state of the warehouse 200 (provided by the current state data 408). All of these decisions are conveyed to the order management system 102, which in one embodiment is also a part of the WES. The order management system 102 is responsible for tracking order components, locking allocated inventory, etc. The controller 304 determines what should be done, and the order management system 102 executes that decision. In one embodiment, the controller 304 and the order management system 102 are combined in the WES.

The agent model 106 is periodically retrained by the RL agent 104 using historical data unique to the particular facility 200 in which it operates. As illustrated in FIG. 2, the historical data includes production data related to the historical orders that have been completed in the facility 200. Such historical data may include one or more of the following:
1. When a particular order was released to the facility 200.
2. Fundamental attributes of the order (i.e., quantity of items, lines, specific order channel, how many different picking zones the order was picked from, processing time stamps related to order release, historical production pick times (when first/last picks occurred, when items were placed on conveyor, arrival of items at put wall, start/completion times).
3. State of the facility at the time the particular was released to the facility 200 (e.g., how many orders were in progress in each order channel, how many workers were at the facility 200 (quantity of pickers/putters).
4. Any other relevant data point that captures something important about the particular order.

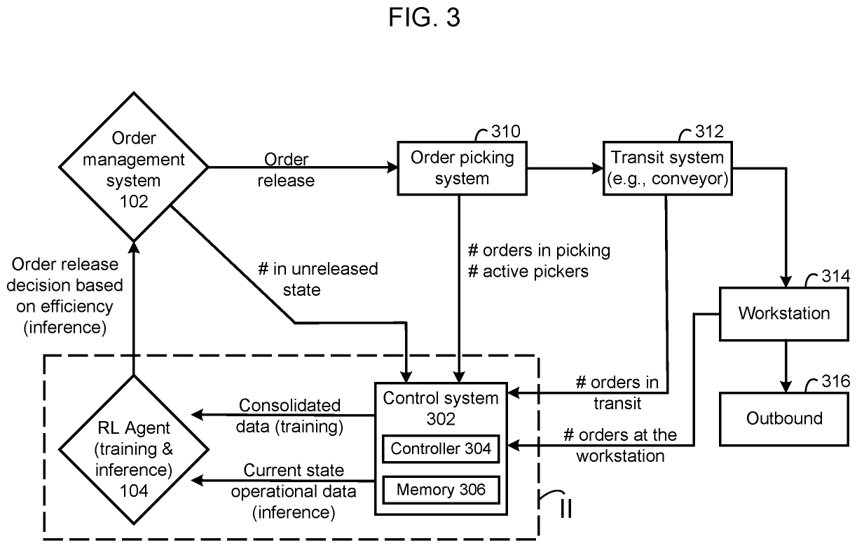

As illustrated in FIG. 3, the historical production data is saved to memory by the warehouse control system 302 receiving order related data inputs from the order management system (i.e., the quantity of orders in an unreleased state), the order picking system 310 (i.e., the quantity of orders in picking and the quantity of active pickers), the transit 312 (i.e., the quantity of orders in transit), and the workstation 314 (i.e., the quantity of orders at the workstation(s) 314).

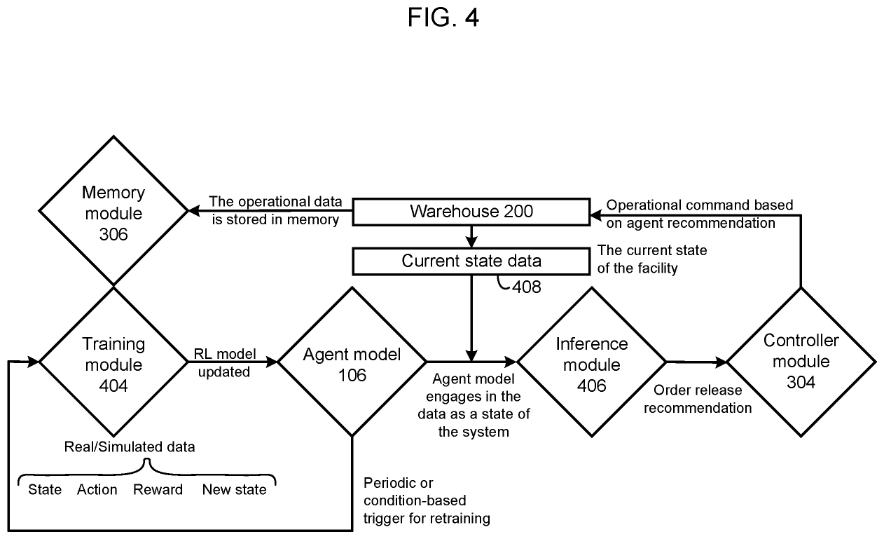

Referring to FIGS. 3 and 4, (and as discussed herein) the agent model 106 will be trained (via reinforcement learning by the training module 404 of the RL agent 104) on a variety of different workdays with both slow days and fewer workers and very busy days with more workers. A variety of days and their corresponding historical orders could be used to teach the agent model 106 how the system responds to different inputs. If there are a lot of workers, how fast can orders be completed, versus times when there are fewer workers? Such a determination would not be a linear scale between “many” workers and “fewer” workers. Such a determination would also be learned function related to the number of workers present in the facility 200. The training comprises an empirical simulation where the agent model is presented with a day's list of orders and simulates the performance of the required facility operations. The simulation does not need to be granular to the point of simulating the movement of a picker moving from place to place and picking individual items. The simulation looks at the orders of a selected historical day and “relives” that day. While the historical data from that day includes the historical production data (e.g., when orders were historically released and how long they took to complete), in training, the agent model 106 will make the decisions about order release.

The training module 404 is operable to train the agent model 106 based on the facility's historical data. In one exemplary embodiment, the reinforcement learning consists of rolling out simulations in parallel while periodically updating shared policy and value neural networks on a central learner for the training module 404. That is, during a training cycle, a central learner periodically updates the agent model 106 based on the ongoing iterative training. In each iteration, the updated model is sent back to the training module to produce new training data for the central learner to use for the next update in an ongoing cyclical process. The training uses standard reinforcement learning techniques such as Soft Actor Critic (SAC) or Proximal Policy Optimization (PPO). The central learner of the training module 404 utilizes graphics processing unit (GPU) acceleration to backpropagate gradients and then synchronously broadcasts updated weights to the worker machine models carrying out a rollout simulation. The central learner is a machine that is running the learning algorithm, and the model is the output of the algorithm. That is, the central learner is like a factory, learning is like the manufacturing process, and the model is like the manufactured good. Training occurs for a pre-specified number of “episodes” for each run, while multiple runs are executed in a hyperparameter search to automatically find the best tunings for the learning parameters. In an alternative embodiment, instead of, or in combination with, the central learner of the training module 404 (providing distributed reinforcement learning (RL)), the training may include decentralized RL where multiple agents or learners act independently and autonomously without any central learner. A benefit of decentralized RL is that privacy and security for the RL systems and methods are preserved.

At each point in time (during the iterative training), the training module 404 provides a learning agent with a description of the current state of the environment. The learning agent takes an action within this environment (e.g., chooses to release a particular order to a selected order channel), and after this interaction, observes a new state of the environment. The learning agent receives a positive reward to promote desired behaviors, or a negative reward to deter undesired behaviors. This selection of an action, and an evaluation of the result is repeated for a plurality of possible order release decisions for a particular decision point.

Consequently, and through repeated interactions in this environment, the learning agent will be able to learn to maximize its reward by releasing orders and gaining the resulting rewards, while minimizing its punishment by avoiding order release decisions that result in unproportional order release across the order channels, undue congestions downstream (e.g., at the put walls or grids), undue delays that result in penalties, and orders that when executed take longer than they should. Based on such information, the learning agent selects an action and subsequently receives the newly reached state of the environment as well as a positive or negative numerical reward feedback. Learning agents are given a positive reward for good actions (such as completing an order or picking a single item) and a negative reward for bad actions (e.g., waiting too long). Such agents receive rewards according to the cumulative effect of their actions over time, as opposed to the reward for a single good or bad action.

Reinforcement learning may also include determining what decision (made by a learning agent) was the decision that caused the success or failure. Because reinforcement learning is a sequence of time steps, rewards, and actions, RL has a way of assigning credit for actions in the past and rewards that happen later on. It is not necessarily the last step in a process that is responsible for the success or failure of the process. In one embodiment, the magnitude of the rewards and penalties can also change.

In one exemplary embodiment, the rewards utilized in the reinforcement learning includes one or more of the following:
1. Time step penalties where fewer penalties are awarded when fewer steps (and/or time) are taken to complete an order.
2. Positive rewards are granted for successfully releasing an order.
3. Penalties are awarded for overflowing downstream stations (put walls, etc.).
4. A penalty is awarded for causing congestion when orders are released.
5. Rewards are awarded for order channel balancing. These awards are proportional to the orders and channels.
6. Penalties and/or positive rewards are awarded based on whether the released orders are in proportion to the unreleased orders.
7. Rewards are awarded to avoid starvation. For example, a penalty is awarded when a released order (to an order channel) causes starvation in another order channel.
8. Rewards are awarded to avoid releasing work into a congested or overflowing work area.

Referring to FIG. 4, after the iterative reinforcement learning has been completed, the agent model 106 is released from the training module 404 to the inference module 406. The Inference module 406 (and the agent model 106) treats the warehouse 200 as a control system where order release recommendations are dynamically adjusted to keep the system stable and maximally efficient. The agent model 106 released to the inference module 406 seeks to maximize optimal WIP via order release recommendations based on the current state data 408. The current state data 408 includes the following data points, which are given in each order channel:
Quantity of orders “in picking.”
Quantity of orders “in transit” to workstation(s) (e.g., on a conveyor).
Quantity of orders occupying workstation(s) (e.g., on a put wall).
Quantity of orders waiting in an unreleased state.
The state of completion of in progress orders.
Labor conditions (e.g., the quantity of various workers).
   Thus, when the optimized agent model 106 receives the current live state of the facility 200, (which includes statistics related to #'s orders in progress (broken down by order channel), the state of the facility, the state of completion of the orders in each order channel, and the #'s of future orders for each order channel to be released), an order release recommendation is provided. Based on the needs of the system, the inference module 406 is periodically provided with the current state of the facility via the current state data 408 and generates an order release recommendation.

Referring to FIG. 4, the inference module 406 (using the agent model 106) is operable to map the current state data 408 of the fulfilment center 200 into a set of recommended actions for order release. In one exemplary embodiment, a digital image containing this agent model 106 and its associated runtime environment is served on a cloud platform using a serverless managed compute platform, which returns actions using a standard web framework (e.g. Flask). As illustrated in FIG. 4, an order release action is output from the inference module 406 for execution by the controller module 304 whenever a live state of the facility 200 is provided to the inference module 406. In one embodiment, the controller module 304 is operable to issue the order release based upon the order release action recommendations from the inference module 406. In another embodiment, the control system 302 provides a cloud services-based centralized data interface for connected systems including on-premise and other cloud service offerings. The control system 302 is also operable to receive data and communication for remote systems as well as to manage, configure, and deploy on-premise agents.

The RL agent 104 periodically retrains the agent model 106 from the historical data unique to the specific customer's facility in which it operates. In one embodiment the agent model 106 is retrained in the training module 404 once a month. Optionally, until the production data collected begins to look markedly different from the production data already collected, the agent model 106 will not be retrained. Such marked differences may include, for example, the additional or subtraction of order channels. In one exemplary embodiment, the agent model 106 is retrained based upon performance metrics.

Accordingly, an exemplary ML/AI of the order management system 102 is configured to tune order release decisions using machine learning to keep the system stable and maximize efficiency by the AI system acting in real-time and dynamically adjusting WIP levels. As discussed herein, rather than a fixed target WIP, the exemplary ML/AI utilizes an optimal WIP level that can adjust at any given time depending on the current state of the system. Performance of the system can therefore be custom tailored as the ML/AI system is trained on historical data specific to its particular customer facility.

Changes and modifications in the specifically described embodiments can be carried out without departing from the principles of the present invention which is intended to be limited only by the scope of the appended claims, as interpreted according to the principles of patent law including the doctrine of equivalents.

1. An order fulfillment control system for a warehouse, the order fulfillment control system comprising:
a controller configured to control fulfillment activities of the warehouse and to issue orders to pickers, wherein the controller is configured to adaptively control the issuance of the orders and to record operational data corresponding to the fulfillment activities in the warehouse;
a memory module configured to hold the operational data;
a current state data storage configured to hold live data corresponding to a current state of the warehouse defined by selected portions of the operational data;
an inference module comprising an order release control, wherein the inference module is operable to issue an order release recommendation to the controller when a set of live data is received from the current state data storage, and wherein the order release recommendation is defined by the order release control with respect to the set of live data; and
a training module configured to retrain the order release control using reinforcement learning, wherein the training module is operable to perform the reinforcement learning using the operational data to retrain and update the order release control, and wherein the training module is configured to retrain the order release control based upon a plurality of priorities for optimal operation of the warehouse.

2. The order fulfillment control system of claim 1, wherein the training module is operable to retrain the order release control by providing the control with a plurality of picking orders for the order release control to coordinate and release for fulfillment in a simulation, wherein the plurality of picking orders are based upon operational data stored in the memory module, and wherein the training module awards numerical penalties and positive rewards based upon evaluated results of the completion of orders as they are released by the order release control.

3. The order fulfillment control system of claim 2, wherein the operational data is at least one of:
operational data recorded during performance of operational tasks within the warehouse;
simulation data configured to simulate warehouse operations; and
synthetic data configured to mimic the operational data.

4. The order fulfillment control system of claim 2, wherein the plurality of picking orders corresponds to an historical day's quantity of picking orders completed on that day.

5. The order fulfillment control system of claim 2, wherein the plurality of picking orders corresponds to a hypothetical day's quantity of picking orders to be completed that day.

6. The order fulfillment control system of claim 1, wherein the warehouse comprises at least one order channel, wherein each of the at least one order channel comprises a corresponding set of resources that are used to complete an order assigned to that order channel.

7. The order fulfillment control system of claim 1, wherein the plurality of priorities for optimal operation of the warehouse comprises at least one of: balancing orders between order channels of the at least one order channel, proportionality of the orders released as compared to the orders still awaiting release, and issuing order releases such that order channels of the at least one order channel are not starved nor congested.

8. The order fulfillment control system of claim 1, wherein the controller is operable to direct the training module to retrain the order release control after a selected time interval or when a measured metric is determined to be outside of an operational window.

9. The order fulfillment control system of claim 1, wherein the orders are picking orders, and wherein the pickers are human pickers and/or robotic pickers.

10. A method for controlling order fulfillment in a warehouse, the method comprising:
controlling fulfillment activities in the warehouse;
issuing orders to pickers, wherein the issuance of orders is adaptively controlled;
recording operational data corresponding to the fulfillment activities in the warehouse;
holding the operational data in a memory module;
holding live data in a current state data storage, wherein the live data corresponds to a current state of the warehouse defined by selected portions of the operational data;
issuing an order release recommendation when a set of live data is received from the current state data storage, wherein the order release recommendation is defined by an order release control with respect to the set of live data; and
retraining the order release control using reinforcement learning, wherein the reinforcement learning is performed using the operational data to retrain and update the order release control, and wherein the retraining is based upon a plurality of priorities for optimal operation of the warehouse.

11. The method of claim 10 further comprising retraining the order release control using a plurality of picking orders for the order release control to coordinate and release for fulfillment in a simulation, wherein an environment for order fulfillment and the plurality of picking orders are based upon operation data stored in the memory module, and wherein penalties and rewards are granted based upon evaluated results after the completion of orders as they are released by the order release control.

12. The method of claim 11, wherein the operational data comprises at least one of:
operational data recorded during performance of operational tasks within the warehouse;
simulation data configured to simulate warehouse operations; and
synthetic data configured to mimic the operational data.

13. The method of claim 11, wherein the plurality of picking orders comprises at least one of one or more historical day's quantity of picking orders completed on respective days, and at least one hypothetical day's quantity of picking orders to be completed on a hypothetical day.

14. The method of claim 11, wherein the warehouse comprises a plurality of order channels, wherein each of the plurality of order channels comprises a corresponding set of downstream resources and associated requirements, and wherein two or more order channels of the plurality of order channels share upstream resources.

15. The method of claim 10, wherein the plurality of priorities for optimal operation of the warehouse comprises at least one of: balancing orders between order channels, proportionality of the orders released as compared to orders still awaiting release, and issuing order releases such that order channels are not starved nor congested.

16. The method of claim 10 further comprising retraining the order release control after a selected time interval or when a measured metric is determined to be outside of an operational window, and wherein the measured metric is one or more of: production metrics and performance metrics.

17. A non-transitory computer-readable medium with instructions stored thereon, that when executed on a processor, perform the steps comprising:
controlling fulfillment activities in a warehouse;
issuing orders to pickers, wherein the issuance of orders is adaptively controlled;
recording operational data corresponding to the fulfillment activities in the warehouse;
holding the operational data in a memory module;
holding live data in a current state data storage, wherein the live data corresponds to a current state of the warehouse defined by selected portions of the operational data;
issuing an order release recommendation when a set of live data is received from the current state data storage, wherein the order release recommendation is defined by an order release control with respect to the set of live data; and
retraining the order release control using the operational data to retrain and update the order release control, and wherein the retraining is based upon a plurality of priorities for optimal operation of the warehouse.

18. The non-transitory computer-readable medium of claim 17 further comprising retraining the order release control using reinforcement learning, and retraining the order release control by providing the control with a plurality of picking orders for the order release control to coordinate and release for fulfillment in a simulation, wherein the plurality of picking orders are based upon operational data stored in the memory module, and wherein numerical penalties and positive rewards are awarded based upon evaluated results of the completion of orders as they are released by the order release control.

19. The non-transitory computer-readable medium of claim 18, wherein the operational data is at least one of:
operational data recorded during performance of operational tasks within the warehouse;
simulation data configured to simulate warehouse operations; and
synthetic data configured to mimic the operational data.

20. The non-transitory computer-readable medium of claim 18, wherein the plurality of picking orders corresponds to an historical day's quantity of picking orders completed on that day.

21. The non-transitory computer-readable medium of claim 18, wherein the plurality of picking orders corresponds to a hypothetical day's quantity of picking orders to be completed that day.

22. The non-transitory computer-readable medium of claim 17, wherein the warehouse comprises at least one order channel, and wherein each of the at least one order channel comprises a corresponding set of resources that are used to complete an order assigned to that order channel.

23. The non-transitory computer-readable medium of claim 17, wherein the plurality of priorities for optimal operation of the warehouse comprises at least one of: balancing orders between order channels of the at least one order channel, proportionality of the orders released as compared to the orders still awaiting release, and issuing order releases such that order channels of the at least one order channel are not starved nor congested.

24. The non-transitory computer-readable medium of claim 17 further comprising retraining the order release control after a selected time interval or when a measured metric is determined to be outside of an operational window.

25. The non-transitory computer-readable medium of claim 24, wherein the measured metric is one or more of: production metrics and performance metrics.

26. The non-transitory computer-readable medium of claim 17, wherein the orders are picking orders, and wherein the pickers are human pickers and/or robotic pickers.
